(19) United States
(12) Patent Application Publication
(10) Pub. No.: US 2019/0031234 A1
(43) Pub. Date: Jan. 31, 2019

(54) METHOD AND CONTROL UNIT FOR OPERATING A MOTOR VEHICLE

(71) Applicant: ZF Friedrichshafen AG, Friedrichshafen (DE)

(72) Inventor: Christoph Schall, Weingarten (DE)

(73) Assignee: ZF Friedrichshafen AG, Friedrichshafen (DE)

(21) Appl. No.: 16/050,206

(22) Filed: Jul. 31, 2018

(30) Foreign Application Priority Data
Jul. 31, 2017 (DE) 102017213193.4

(51) Int. Cl. B62D 6/00

(52) U.S. Cl. CPC B62D 6/002

(57) ABSTRACT

A method is provided for operating a motor vehicle that has steerable front wheels and steerable rear wheels, wherein a target reference point trajectory is determined for a reference point of the motor vehicle, depending on which the movement of the motor vehicle is controlled. The target reference point trajectories are converted to a target front axle trajectory for a front axle reference point and a target rear axle trajectory for a rear axle reference point. A first steering angle for the front wheels and a second steering angle for the rear wheels are determined on the basis of the target front axle trajectory and the target rear axle trajectory, such that the front axle reference point moves along the target front axle trajectory, and the rear axle reference point moves along the target rear axle trajectory.

### RELATED APPLICATIONS

This application claims the benefit and priority of German Patent Application No. DE 10 2017 213 193.4, filed Jul. 31, 2017, which is incorporated by reference herein in its entirety.

### TECHNICAL FIELD

The invention relates to a method for operating a motor vehicle. Moreover, the invention relates to a control device for executing the method.

### BACKGROUND

Motor vehicles are already known in the field, which have both steerable front wheels and steerable rear wheels. Motor vehicles with steerable front wheels and steerable rear wheels are also referred to as motor vehicles with all-wheel steering.

A parking assistance device for a vehicle with both steerable front wheels and steerable rear wheels is known from US 2010/0286872 A1. The parking assistance device has a calculating device, which calculates a travel pathway for directing the motor vehicle to a target position, wherein opposing steering angles are selected for the front wheels and rear wheels, and the travel pathway comprises a section in which a constant point located on a center line of the vehicle generates a trajectory. For such a constant point to lie on the center line of the vehicle, a constant relationship between a steering angle for the front wheels and a steering angle for the rear wheels must be permanently maintained.

Such a constant steering angle relationship severely limits operation of the motor vehicle, however. Thus, according to US 2010/028687 A1, the vehicle must stop in order to be able to alter the steering angle, because the front axle steering and the rear axle steering have different gradients. Furthermore, it is also impossible for the front wheels and rear wheels to assume steering angles in the same direction with the method in US 2010/028687 A1. Instead, according to the prior art, it is necessary for the front wheels and the rear wheels to assume opposing steering angles, this being, as stated above, while maintaining a constant steering angle relationship between the steering angle at the front axle and the steering angle at the rear axle.

### BRIEF SUMMARY

Based on background above, the object of certain embodiments of the present disclosure is to create a novel method for operating a motor vehicle and a control device for operating a motor vehicle.

According to certain aspects of the present disclosure, the target reference point trajectory is converted to a front axle trajectory for a front axle reference point, and to a target rear axle trajectory for a rear axle reference point. A first steering angle for the front wheels of the motor vehicle and a second steering angle for the rear wheels of the motor vehicle are determined on the basis of the target front axle trajectory and on the basis of the target rear axle trajectory, such that the front axle reference point moves along the target front axle trajectory and the rear axle reference point moves along the target rear axle trajectory.

Operation of a motor vehicle with directed front wheels as well as directed rear wheels can be significantly improved with the certain aspects of the present disclosure. It is thus possible to set a steering angle for the front wheels at the front axle and a steering angle for the rear wheels at the rear axle, without the necessity of maintaining a constant steering angle relationship between these steering angles. It is then possible to independently correct for a lateral offset at the front axle and a lateral offset at the rear axle. Furthermore, a deviation in the alignment of the longitudinal center axis of the motor vehicle can be corrected for via both the steering angle of the front wheels as well as the steering angle of the rear wheels. Moreover, it is possible to set steering angles at the front wheels and the rear wheels in the same direction, such that the vehicle can travel in a so-called crab-walk, in which the front axle and the rear axle, or the front wheels and the rear wheels assume the exact same steering angles.

According to an advantageous further development, the target reference point trajectory is converted to the target front axle trajectory such that each reference point on the target reference point trajectory is converted to a corresponding front axle reference point of the target front axle trajectory, depending on an associated first steering angle, an associated second steering angle, an associated position of the reference point in relation to the front axle reference point, and an associated alignment of a longitudinal axis of the motor vehicle. This enables a particularly advantageous determination of the target front axle trajectory.

According to an advantageous further development, the target reference point trajectory is converted to the target rear axle trajectory such that each reference point on the target reference point trajectory is converted to a corresponding rear axle reference point of the target rear axle trajectory, depending on an associated first steering angle, an associated second steering angle, an associated position of the reference point in relation to the rear axle reference point, and an associated alignment of the longitudinal axis of the motor vehicle. This enables a particularly advantageous determination of the target rear axle trajectory.

The target front axle trajectory preferably defines X % of the first steering angle for the front wheels and Y % of the second steering angle for the rear wheels. The target rear axle trajectory defines X % of the second steering angle for the rear wheels and Y % of the first steering angle for the front wheels. Therefore: X %+Y %=100%. As a result, it is possible to optimally correct for the lateral offset of the front axle and rear axle as well as the deviation in the alignment of the longitudinal center axis.

This preferably first takes place through a pre-control, insofar as the target rear axle trajectory defines the first steering angle for the front wheels. The target front axle trajectory analogously defines the second steering angle for the rear wheels. Furthermore, the steering angles at the front and rear axles defined by the trajectories can be combined through respective offset steering angles, which corrects for the lateral offset to the two trajectories. Analogously, an offset steering angle can also be obtained that directs the vehicle along the alignment of the longitudinal center axis defined by the trajectories, wherein the alignment is adjusted by only the front axle steering or only the rear axle steering, or by a combination of both steering systems.

Preferred further developments can be derived from the dependent claims and the following description. Exemplary embodiments of the invention shall be explained in greater detail on the basis of the drawings, without being limited thereto. Therein:

### BRIEF DESCRIPTION OF THE DRAWINGS

FIG. 1 shows motor vehicle with steerable front wheels and steerable rear wheels;

FIG. 2 shows a diagram for further clarification of the invention.

### DETAILED DESCRIPTION

Certain aspects of the present disclosure relates to a method for operating a motor vehicle and a control device for executing the method.

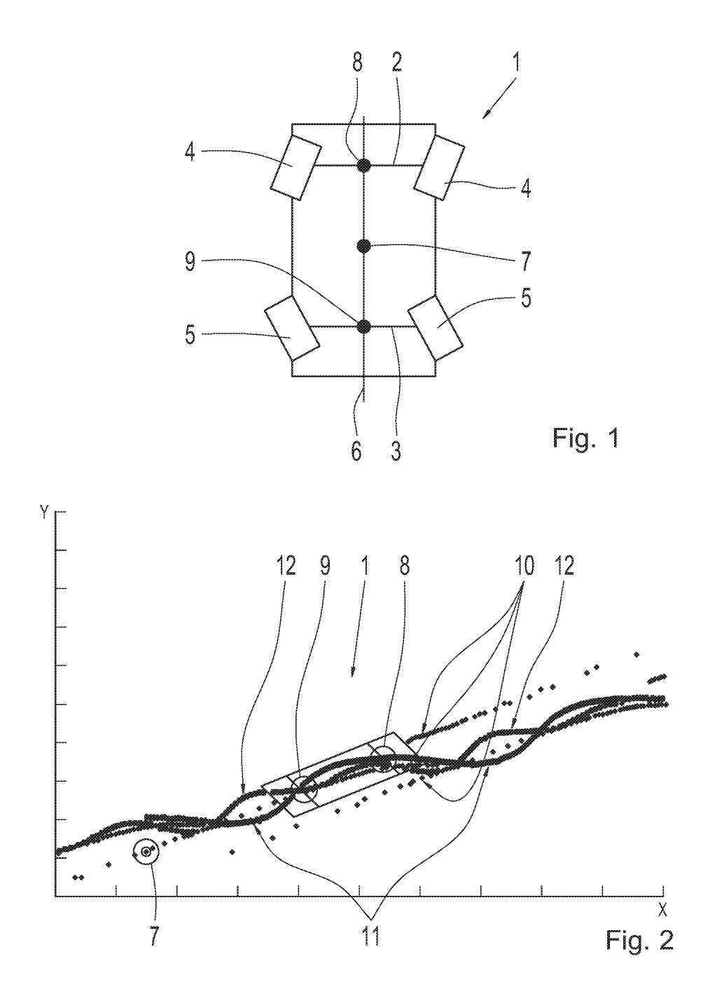

FIG. 1 shows a highly schematic illustration of a motor vehicle, which is to be operated using the method according to the invention and using the control device according to the invention.

The motor vehicle 1 shown in FIG. 1 has a front axle 2 with steerable front wheels 4 and a rear axle 3 with steerable rear wheels 5. Furthermore, FIG. 1 shows a longitudinal center axis 6 of the motor vehicle 1.

To operate a motor vehicle with steerable front wheels 4 and steerable rear wheels 5, e.g. when parking or in comparable operating situations, a target reference point trajectory for a reference point 7 of the motor vehicle 1 is determined, depending on which the movement of the motor vehicle is controlled, e.g. for an automated parking procedure.

Each point along the target reference point trajectory is characterized thereby by at least the position of the respective point in a reference coordinate system along the X axis and the Y axis, as well as by the alignment of the longitudinal axis 6 of the vehicle 1 in the reference coordinate system. Moreover, each point is preferably characterized by a first steering angle for the front wheels 4, a second steering angle for the rear wheels 5, and by a speed of the motor vehicle.

The reference point of the target reference point trajectory is preferably the point of rotation about which the motor vehicle turns during the movement. Then, when only the rear wheels 4 are used for a steering procedure, this point of rotation is located on the front axle 2. When only the front wheels 4 are used for steering, this point of rotation is then located on the rear axle 3. If both the front wheels 4 and the rear wheels 5 are used for steering, this point of rotation, or reference point, lies between the front axle 2 and the rear axle 3, or in front of the front axle 2 or behind the rear axle 3, depending on whether identical or opposing steering angles are used at the front wheels 4 and the rear wheels 5. The position of the point of rotation, or the reference point, only remains constant when a steering angle relationship between the first steering angle for the front wheels 4 and the second steering angle for the rear wheels 5 is constant when the steering angles are opposed.

To determine the target reference point trajectory 10 for the reference point of the motor vehicle, or the point of rotation for the motor vehicle, the current position of the motor vehicle 1, specifically the current position of the reference point of the motor vehicle 1 in the reference coordinate system, the current alignment of the longitudinal axis of the motor vehicle in the reference coordinate system, the current first steering angle for the front wheels 4, the current second steering angle for the rear wheels 5, and preferably the current speed of the motor vehicle 1 are used in order to determine the target reference point trajectory for the reference point 7, or the point of rotation for the motor vehicle 1 as an output value.

Depending on this target reference point trajectory, the movement of the motor vehicle can be controlled, wherein this takes place according to the prior art as a direct function of the target reference point trajectory.

It is proposed with the invention that the movement of the motor vehicle is not controlled as a direct or indirect function of the target reference point trajectory 10, but instead, to convert the target reference point trajectory 10 to a target front axle trajectory 11 for a front axle reference point 8 and a target rear axle trajectory 12 for a rear axle reference point 9 of the motor vehicle.

The first steering angle for the front wheels 4 and the second steering angle for the rear wheels 5 are then determined on the basis of the target front axle trajectory 11 and the target rear axle trajectory 12, such that the front axle reference point 8 moves along the target front axle trajectory 11 and the rear axle reference point 9 moves along the target rear axle trajectory 12.

Various grid points for the target reference point trajectory 10 are plotted in a reference coordinate system along the X and Y axes in FIG. 2, this being for the case in which sine-wave steering angles are applied to the front wheels 4 and rear wheels 5 with different sine-wave frequencies, wherein the frequency at the rear wheels 5 is twice that of the frequency at the front wheels 4.

As stated above, the target reference point trajectory 10 is determined as a function of the current position of the reference point 7 in the reference coordinate system, the alignment of the longitudinal center axis 6 of the motor vehicle 1 in the reference coordinate system, the current steering angle for the front wheels 4, the current second steering angle for the rear wheels 5, and the current speed of the motor vehicle 1, this being either in an iterative manner, or on the basis of a system of equations.

Due to the fact that there is no constant steering angle relationship between the first steering angle of the front wheels 4 and the second steering angle of the rear wheels 5, adjacent grid points of the target reference point trajectory 10 are subjected to large changes, because the reference point, or point of rotation 7 can change significantly, even with small changes in steering angles.

The target reference point trajectories 10 of the reference points or points of rotation 7 of the motor vehicle 1 are then converted to the target front axle trajectory 11 and the target rear axle trajectory 12, as explained above.

The target reference point trajectory 10 is converted to the target front axle trajectory 11 such that each reference point 7 on the target reference point trajectory 10 can be converted to a corresponding front axle reference point of the target front axle trajectory 11, depending on an associated first steering angle of the front wheels, an associated second steering angle of the rear wheels, an associated position of the reference point 7 in relation to the front axle reference point 8 and the associated alignment of the longitudinal center axis 6 of the motor vehicle 1. The target reference point trajectory is converted to the target rear axle trajectory 12 in an analogous manner, specifically such that each reference point 7 on the target reference point trajectory 10 is converted to a corresponding rear axle reference point 9 of the target rear axle trajectory 12, depending on an associated first steering angle of the front wheels 4, an associated second steering angle of the rear wheels 5, an associated position of the reference point in relation to the rear axle reference point 9, and an associated alignment of the longitudinal center axis 6.

The steering angles for the front wheels 4 and the rear wheels 5 are then determined on the basis of the target front axle trajectory 11 and on the basis of the target rear axle trajectory 12, this being such that the front axle reference point 8 moves along the target front axle trajectory 11 and the rear axle reference point 9 moves along the target rear axle trajectory 12.

The target front axle trajectory 11 can then define the steering angle for the front wheels 4, and the target rear axle trajectory 12 can define the second steering angle for the rear wheels 5.

Alternatively, the target front axle trajectory 11 can define the steering angle for the rear wheels 5, and the target rear axle trajectory 12 can define the first steering angle for the front wheels 4.

It is likewise possible to divide the effects of the target front axle trajectory 11 and the target rear axle trajectory 12 on the two steering angles for the front wheels 4 and the rear wheels 5 in percentages, specifically such that the target front axle trajectory defines X % of the first steering angle for the front wheels 4 and Y % of the second steering angle for the rear wheels 5, such that the target rear axle trajectory 12 defines X % of the second steering angle for the rear wheels 5 and Y % of the first steering angle for the front wheels 4, wherein X %+Y %=100%.

It is possible to control steering angles for the front wheels 4 and steering angles for the rear wheels 5 independently with the invention. Thus, a lateral offset of the reference point 8 for the front axle 2 and a lateral offset of the rear axle reference point 9 for the rear axle 3 can be determined separately, and corrected for independently. Thus, the front axle steering of the front wheels 4 can correct for the lateral offset of the rear axle 3, or the front axle steering can correct for the lateral offset of the front axle 2. Likewise, the rear axle steering can correct for the lateral offset at the front axle 2, or the rear axle steering can correct for the lateral offset at the rear axle 3.

Furthermore, deviations in the longitudinal center axis 6 of the vehicle 1 can be corrected in a variable manner by the front axle steering and/or the rear axle steering, via independent selections of the two steering angles in relation to one another, without a constant steering angle relationship. It is possible thereby, to divide the effects of the two steering angles for the front wheels 4 and the rear wheels 5 in percentages, specifically such that the deviation in relation to the longitudinal center axis is corrected X % by the first steering angle for the front wheels, and Y % by the second steering angle for the rear wheels 5, wherein X %+Y %=100%.

It is also possible with the invention to operate the motor vehicle 1 in a so-called crab-walk, in which steering angles are set in the same direction for the front wheels 4 and for the rear wheels 5, in which a point of rotation for the motor vehicle 1 is then located in front of or behind the vehicle, and if the steering angles are identical, extends into infinity. Accordingly, it is not necessary, as is the case in the prior art, to use opposing steering angles on the wheels 4, 5, and maintain a constant relationship between the steering angles.

The invention also relates to a control device for operating the motor vehicle 1 with steerable front wheels 4 and steerable rear wheels 5.

The control device has a trajectory calculating device, which calculates the target reference point trajectories 10 and also converts the target reference point trajectories 10 to the target front axle trajectory 11 and the target rear axle trajectory 12.

Furthermore, the control device comprises a trajectory control device, which determines the steering angles for the front wheels 4 and the rear wheels 5 on the basis of the target front axle trajectory 11 and the target rear axle trajectory 12, such that the front axle reference point 8 moves along the target front axle trajectory 11, and the rear axle reference point 9 moves along the target rear axle trajectory 12.

### REFERENCE SYMBOLS

1 motor vehicle
2 front axle
3 rear axle
4 front wheels
5 rear wheels
6 longitudinal axis
7 reference point
8 front axle reference point
9 rear axle reference point
10 target reference point trajectory
11 target front axle trajectory
12 target rear axle trajectory

1. A method for operating a motor vehicle that has steerable front wheels and steerable rear wheels with a target reference point trajectory, wherein control of movement of the motor vehicle depends on the determination of the target reference point trajectory, the method comprising:
converting the target reference point trajectory to a target front axle trajectory for a front axle reference point and a target rear axle trajectory for a rear axle reference point, and
determining a first steering angle for the front wheels and a second steering angle for the rear wheels based on the target front axle trajectory and the target rear axle trajectory such that the front axle reference point moves along the target front axle trajectory and the rear axle reference point moves along the target rear axle trajectory.

2. The method according to claim 1, wherein each reference point of a plurality of reference points on the target reference point trajectory is converted to a corresponding front axle reference point of the target front axle trajectory based on an associated first steering angle, an associated second steering angle, an associated position of the reference point in relation to the front axle reference point, and an associated alignment of a longitudinal axis of the motor vehicle.

3. The method according to claim 1, wherein each reference point of a plurality of reference points on the target reference point trajectory is converted to a corresponding rear axle reference point of the target rear axle trajectory based on an associated first steering angle, an associated second steering angle, an associated position of the reference point in relation to the rear axle reference point, and an associated alignment of the longitudinal axis of the motor vehicle.

4. The method according to claim 1, wherein the target front axle trajectory defines the first steering angle for the front wheels, and the target rear axle trajectory defines the second steering angle for the rear wheels.

5. The method according to claim 1, wherein the target front axle trajectory defines the second steering angle for the rear wheels, and the target rear axle trajectory defines the first steering angle for the front wheels.

6. The method according to claim 1, wherein the target front axle trajectory defines X % of the first steering angle for the front wheels and Y % of the second steering angle for the rear wheels, and wherein the target rear axle trajectory defines X % of the second steering angle for the rear wheels and Y % of the first steering angle for the front wheels, wherein X %+Y %=100%.

7. A control device for operating a motor vehicle with steerable front wheels and steerable rear wheels,
wherein the control device determines a target reference point trajectory for the motor vehicle,
wherein the control device converts the target reference point trajectory to a target front axle trajectory for a front axle reference point and a target rear axle trajectory for a rear axle reference point,
wherein the control device determines a first steering angle and a second steering angle on the basis of the target front axle trajectory and the target rear axle trajectory, such that the front axle reference point moves along the target front axle trajectory and the rear axle reference point moves along the target rear axle trajectory, and
wherein the control device sends an output signal to control movement of the motor vehicle based on the steering angles.

8. The control device according to claim 7, wherein the control device comprises a trajectory calculating device that calculates the target reference point trajectory, and converts the target reference point trajectory to the target front axle trajectory and the target rear axle trajectory.

9. (canceled)

10. The control device of claim 8, wherein the control device comprises a trajectory control device that determines the steering angles on the basis of the target front axle trajectory and the target rear axle trajectory, such that the front axle reference point moves along the target front axle trajectory, and such that the rear axle trajectory moves along the target rear axle trajectory.

11. The control device of claim 8, wherein each reference point of a plurality of reference points on the target reference point trajectory is converted to a corresponding rear axle reference point of the target rear axle trajectory based on an associated first steering angle, an associated second steering angle, an associated position of the reference point in relation to the rear axle reference point, and an associated alignment of the longitudinal axis of the motor vehicle.

12. The control device of claim 8, wherein the target front axle trajectory defines a first steering angle for the front wheels, and the target rear axle trajectory defines a second steering angle for the rear wheels.

13. The control device of claim 8, wherein the target front axle trajectory defines the second steering angle for the rear wheels, and the target rear axle trajectory defines the first steering angle for the front wheels.

14. The control device of claim 8, wherein the target front axle trajectory defines X % of the first steering angle for the front wheels and Y % of the second steering angle for the rear wheels, and wherein the target rear axle trajectory defines X % of the second steering angle for the rear wheels and Y % of the first steering angle for the front wheels, wherein X %+Y %=100%.

15. A motor vehicle, comprising:
steerable front wheels and steerable rear wheels; and
a control device for controlling the steerable front wheels and the steerable rear wheels,
wherein the control device determines a target reference point trajectory for the motor vehicle,
wherein the control device converts the target reference point trajectory to a target front axle trajectory for a front axle reference point and a target rear axle trajectory for a rear axle reference point,
wherein the control device determines a first steering angle and a second steering angle on the basis of the target front axle trajectory and the target rear axle trajectory, such that the front axle reference point moves along the target front axle trajectory and the rear axle reference point moves along the target rear axle trajectory, and
wherein the control device sends an output signal to control movement of the motor vehicle based on the steering angles.

16. The motor vehicle of claim 15, wherein the control device comprises a trajectory calculating device that calculates the target reference point trajectory, and converts the target reference point trajectory to the target front axle trajectory and the target rear axle trajectory.

17. The motor vehicle of claim 15, wherein the control device comprises a trajectory control device that determines the steering angles on the basis of the target front axle trajectory and the target rear axle trajectory, such that the front axle reference point moves along the target front axle trajectory, and such that the rear axle trajectory moves along the target rear axle trajectory.

18. The motor vehicle of claim 15, wherein each reference point of a plurality of reference points on the target reference point trajectory is converted to a corresponding rear axle reference point of the target rear axle trajectory based on an associated first steering angle, an associated second steering angle, an associated position of the reference point in relation to the rear axle reference point, and an associated alignment of the longitudinal axis of the motor vehicle.

19. The motor vehicle of claim 15, wherein the target front axle trajectory defines the first steering angle for the front wheels, and the target rear axle trajectory defines the second steering angle for the rear wheels.

20. The motor vehicle of claim 15, wherein the target front axle trajectory defines the second steering angle for the rear wheels, and the target rear axle trajectory defines the first steering angle for the front wheels.
The motor vehicle of claim 15, wherein the target front axle trajectory defines X % of the first steering angle for the front wheels and Y % of the second steering angle for the rear wheels, and wherein the target rear axle trajectory defines X % of the second steering angle for the rear wheels and Y % of the first steering angle for the front wheels, wherein X %+Y %=100%.
